(19) United States
(12) Patent Application Publication
(10) Pub. No.: US 2018/0238429 A1
(43) Pub. Date: Aug. 23, 2018

(54) GEAR TRANSMISSION STAGE

(71) Applicant: Miba Sinter Austria GmbH, Laakirchen (AT)

(72) Inventors: Mario MITTERMAIR, Gampern (AT); Karl DICKINGER, Vorchdorf (AT)

(73) Assignee: Miba Sinter Austria GmbH, Laakirchen (AT)

(21) Appl. No.: 15/954,026

(22) Filed: Apr. 16, 2018

Related U.S. Application Data
(62) Division of application No. 14/385,613, filed on Sep. 16, 2014.

(30) Foreign Application Priority Data
May 15, 2012 (AT) A50182/2012

(51) Int. Cl. F16H 55/06; F16H 57/00

(52) U.S. Cl. CPC F16H 55/06; Y10T 74/19679; F16H 57/0006

(57) ABSTRACT

A gear transmission stage has two intermeshing gears hardened by heat treatment. In order to improve the noise behavior, one of the two gears has a final form determined by hard fine machining and the other gear has a form which is determined by heat treatment and is close to finished contours.

### CROSS REFERENCE TO RELATED APPLICATIONS

This application is a divisional of and Applicant claims priority under 35 U.S.C. §§ 120 and 121 of U.S. application Ser. No. 14/385,613 filed on Sep. 16, 2014, which application is a national stage application under 35 U.S.C. § 371 of PCT Application No. PCT/AT2013/050065 filed on Mar. 18, 2013, which claims priority under 35 U.S.C. §119 of Austrian Application No. A50182/2012 filed on May 15, 2012, the disclosure of which is incorporated by reference. A certified copy of priority Austrian Patent Application No. A50182/2012 is contained in parent U.S. application Ser. No. 14/385,613. The International Application under PCT article 21(2) was not published in English.

### BACKGROUND OF THE INVENTION

### 1. Field of the Invention

The invention relates to a gear transmission stage consisting of two intermeshing gears hardened by heat treatment.

### 2. Description of the Prior Art

Heat treatment for hardening the tooth flanks in particular is generally provided for heavy-duty gears. Such heat treatments lead to distortions however which impair the meshing quality, so that the gears are usually subjected to hard fine machining after heat treatment, usually by grinding. Despite the low production tolerance enabled by this subsequent treatment and the resulting high meshing quality, the noise behaviour remains unsatisfactory. Spur gears with helical toothing which are more difficult to produce are used in the case of higher requirements placed on the noise behaviour of gear transmission stages, as are used for example in gear transmissions for balancing of masses or for control drives of internal combustion engines, which spur gears offer advantages concerning the noise behaviour.

### SUMMARY OF THE INVENTION

The invention is therefore based on the object of providing a heavy-duty gear transmission stage in which the noise behaviour can be improved considerably.

Based on a gear transmission stage of the kind mentioned above, this object is achieved by the invention in such a way that one of the two gears has a final form determined by hard fine machining and the other gear has a form which is determined by heat treatment and is close to finished contours.

The invention is based on the finding that in the case of tolerance-free meshing the engagement of the tooth occurs at constant speed without deviations at a specific frequency, the so-called meshing frequency. The energy transmitted between the gears thus concentrates at this meshing frequency, which leads to a respective noise level in the meshing frequency. If this excitation energy caused by the meshing can be distributed to a frequency band, the amplitudes of the individual oscillation frequencies decrease, which is perceived in a psyschoacoustical respect as a considerable improvement in the noise behaviour. Furthermore, dividing the excitation energy to several frequencies supports damping of the structure-borne sound. If therefore the gear of a pair of gears is produced after its heat treatment by hard fine machining with only low production tolerances, whereas the other gear is not subjected to such hard fine machining anymore and therefore has a form close to the finished contours which is determined by the heat treatment, no distinct meshing frequency is obtained. Instead, a frequency band is obtained as a result of the distortions by the heat treatment maintained in the one gear with the effect that the excitation energy is divided among several frequencies and the noise event is perceived psychoacoustically more like a hissing noise than a sound. It is obvious that the deviations permitted by production close to the finished contours must not exceed a specific tolerance range in order to avoid accepting additional oscillation excitations which have an adverse effect on the noise behaviour. Since heavy-duty gears must already have a tooth form prior to the heat treatment which corresponds to the finished form with low tolerances, the distortions occurring during the heat treatment in the tooth region usually remain in a tolerance range which leads to a desired broader frequency band in the noise development in the pairing of such gears with hard-finished gearwheels.

If the gears of such a gear transmission stage are made of sintered steel, especially advantageous properties concerning the noise development can thus be ensured, because the damping effect of the sintered body can be utilised additionally in the transmission of the structure-borne sound. Especially when using at least one gear made of sintered steel, it is possible to ensure a noise behaviour for spur gears by means of a gear transmission stage in accordance with the invention which can be achieved in conventional gear transmission stages with helical spur gears at best. It is obvious that a further improvement in the noise behaviour can be achieved with gears arranged with helical gearing in accordance with the invention.

What is claimed is:

1. A method for forming a gear transmission stage comprising a first gear and a second gear, the method comprising steps of:
providing the first gear and the second gear, the first gear and the second gear comprising sintered steel and having teeth, respectively;
subsequently subjecting the first gear and the second gear to a heat treatment such that the first gear and the second gear are hardened;
subsequently hard fine machining the first gear;
wherein the hard fine machining produces a final form of the first gear; and
wherein the heat treatment produces a final form of the second gear.

2. The method according to claim 1, wherein the first gear and the second gear are spur-toothed spur gears.

3. A method of operating the gear transmission stage formed according to the method of claim 1, the method comprising a step of:
intermeshing the first gear and the second gear such that the teeth of the first gear engage the teeth of the second gear;
wherein, as the teeth of the first gear engage the teeth of the second gear, a frequency band is obtained in that excitation energy from the first gear and the second gear is divided among several frequencies.
